(19) United States
(12) Patent Application Publication
(10) Pub. No.: US 2026/0080515 A1
(43) Pub. Date: Mar. 19, 2026

(54) METHOD FOR REDUCING GRID ARTIFACTS IN X-RAY IMAGES

(71) Applicant: Siemens Healthineers AG, Forchheim (DE)

(72) Inventors: Sebastian Käppler, Nürnberg (DE); Philipp Bernhardt, Forchheim (DE)

(21) Appl. No.: 19/307,445

(22) Filed: Aug. 22, 2025

(30) Foreign Application Priority Data
Sep. 17, 2024 (DE) 10 2024 208 841.2

(51) Int. Cl. G06T 5/70; G06T 5/50

(52) U.S. Cl. CPC G06T 5/70; G06T 5/50; G06T 2207/10116; G06T 2207/20224; G06T 2207/30004

(57) ABSTRACT

A method is provided for reducing image errors (e.g., grid artifacts) caused by an anti-scatter grid in an X-ray image that has been recorded with an X-ray facility having an anti-scatter grid. The method includes: receiving an X-ray image that has been recorded while making use of an anti-scatter grid; generating an intermediate image by applying a logarithm transformation to the X-ray image; receiving at least one eigenvector or eigenvector image of the anti-scatter grid established by way of principal component analysis; adapting the at least one eigenvector or eigenvector image to the intermediate image; establishing a weight for at least one eigenvector or eigenvector image dependent upon the result of the adaptation; generating a corrected intermediate image by subtracting the at least one weighted eigenvector or eigenvector image from the intermediate image; and generating a corrected X-ray image by applying the inverse logarithm transformation to the corrected intermediate image.

The present patent document claims the benefit of German Patent Application No. 10 2024 208 841.2, filed Sep. 17, 2024, which is hereby incorporated by reference in its entirety.

### TECHNICAL FIELD

The disclosure relates to a method for reducing image errors (so-called grid artifacts) caused by an anti-scatter grid in an X-ray image that has been recorded with an X-ray facility having an anti-scatter grid, wherein the anti-scatter grid does not need to have a spatially periodically repeating geometric form, and wherein a calibration image recorded without an image-forming object is used. In addition, the disclosure relates to an X-ray facility, a computer program, and an electronically readable data carrier.

### BACKGROUND

During X-ray imaging, the image quality is negatively influenced by scattered radiation. It is known to use anti-scatter grids in order to reduce interfering contributions from scattered radiation in the X-ray image obtained. Anti-scatter grids may be used, in particular, in the field of angiographic imaging. Known technical implementations mainly use anti-scatter grids that make use, for X-ray absorption, of lead lamellae that may be made extremely thin. Although the lamellae may have very thin lamellar walls, they may nevertheless cause grid artifacts in the X-ray image. Therefore, anti-scatter grids are taken into account during the calibration of the imaging X-ray facility and the processing of the X-ray images.

Modern anti-scatter grids do not, however, reduce scattered radiation completely. Indeed, for improved reduction of scattered radiation in, for example, CT imaging, anti-scatter grids with large lamellar heights are known, which may filter out a significantly greater scattered radiation component. However, the X-ray opaque lamellar walls are visible in the image, in particular, on detection with C-arm detectors and are perceived as interfering. Particularly with C-arm X-ray facilities, the X-ray transmission also changes dependent upon mechanical deformations of the C-arm that may be caused, for example, by gravity or by movements of the C-arm. This effect becomes more severe with increasing lamellar height, since the lamellar walls may become tilted due to deformation relative to the X-ray beam and may therefore become more visible in the X-ray image.

From U.S. Patent Application Publication No. 2020/0258222 A1, a method for training a function of an X-ray system is known in which the detector is positioned at a plurality of different positions. At least one X-ray recording is made at each of the positions. Then artifacts generated for the function by the anti-scatter grid are learned by way of machine learning.

From U.S. Patent Application Publication No. 2017/0296131 A1, a method is known for correcting an X-ray image recorded with an X-ray facility with an anti-scatter grid. The anti-scatter grid has a spatially periodically repeating geometric form. An image recorded without an imaging object and an X-ray image are transformed by way of a Fourier transform into the spatial frequency domain. In the spatial frequency domain, a degree of matching between the X-ray image and the calibration image is optimized by adapting the calibration image. The adapted calibration image is subtracted from the X-ray image and the X-ray image is transformed back into the spatial domain. A disadvantage of this method lies in that it requires a spatially periodically repeating configuration of the grid. The transformation into a multidimensional spatial frequency domain for multidimensional grids may be extremely complex and, in relatively complex grid structures with longer lamellae, may possibly not even function. A further disadvantage of this method lies in the fact that elements of the imaging object may have spatial frequencies that influence the adaptation of the calibration image and, as a result, may be unintentionally removed during the subtraction.

From DE 10 2013 223 392 A1, a method is known for the reduction of artifacts arising due to an anti-scatter grid placed on an X-ray detector in which the transmission image or an item of information derived therefrom is used for establishing a three-dimensional grid model describing the recording geometry used including the anti-scatter grid. For each pixel of the transmission image, a correction value describing the absorption by the anti-scatter grid for the pixel is established by forward projection according to the grid model. The transmission image is corrected making use of the correction values.

From DE 10 2012 217 612 A1, an anti-scatter grid is known for arrangement with an X-ray detector, having an active matrix of rectangular pixel elements. The anti-scatter grid has lamellae made of an X-ray absorbing material that are arranged in a hexagonal matrix structure. The hexagonal matrix structure is arranged tilted relative to the pixel elements of the X-ray detector by an angle of between 10° and 20°, in particular, 15°.

From the publication “Scatter correction using a primary modulator on a clinical angiography C-arm CT system,” by Bastian Bier et al., Med Phys. 2017 September; 44(9):e125-e137. doi: 10.1002/mp.12094. Epub 2017 Feb. 10, an improved scatter estimation is known in which a primary radiation modulator is used, which is included between the X-ray radiator and the object. The modulation enables an estimation of the scatter in the projection region in that a target function is optimized in relation to the scatter estimate.

### SUMMARY AND DESCRIPTION

It is an object of the disclosure to reduce grid artifacts in an X-ray image and to improve the reduction in the visibility of an anti-scatter grid that is perceptible as a visually interfering anti-scatter grid shadow or grid artifact.

The scope of the present disclosure is defined solely by the appended claims and is not affected to any degree by the statements within this summary. The present embodiments may obviate one or more of the drawbacks or limitations in the related art.

The disclosure achieves this object with a correcting method. The cause of the visibility of the anti-scatter grid is the locally varying primary transmission of the anti-scatter grid. The correcting method estimates the locally varying primary transmission.

With the aid of knowledge of the local primary transmission, the visibility of the anti-scatter grid may be corrected and/or reduced, for example, by subtraction.

The method includes two phases. In phase 1 of the method, an offline calibration takes place. The process includes: (1) calibration of the system: Images of the anti-scatter grid are recorded under different conditions (X-ray tube spectra, X-ray filters, geometric projection directions, also referred to as angulations, X-ray tube focal spot size). The recordings may be carried out so that the X-ray filter generates as little scattered radiation as possible.

The process further includes: (2) establishing a grid model by principal component analysis. The recorded images of the anti-scatter grid are linearized by logarithmic transformation. From the images, a mean image is formed. The mean image is subtracted from the individual images. From the resulting images, eigenvectors are established by principal component analysis. Therein, in practice, a restriction to a certain quantity of eigenvectors is accepted in order to limit the calculation effort and to achieve a good cost-benefit ratio. Each eigenvector then corresponds to an eigenvector image of the grid in vector format and/or an eigenvector image of the grid may be generated on the basis of each eigenvector in a format other than a vector format.

Phase 2 of the method relates to use during operation. In this phase, the process includes: (1) if an X-ray image of an object is recorded, advantageously, an estimation of the scattered radiation may initially be carried out. The estimation of the scattered radiation may be carried out while taking account of the physically relevant properties of the grid. The estimated scattered radiation component is subtracted. The estimation and subtraction of the scattered radiation are acts that make the subsequent reduction of grid artifacts particularly effective.

The process also includes: (2) the possibly scattered radiation-reduced X-ray image is linearized by logarithm transformation. Subsequently, the mean image previously formed in phase 1 is subtracted.

The process also includes: (3) subsequently, an adaptation (fitting) of the eigenvectors and/or eigenvector images to the X-ray image is carried out. On the basis of the results of the fitting, the eigenvectors and/or eigenvector images of the grid are weighted. The eigenvectors weighted in this way and/or eigenvector images of the grid are subtracted from the X-ray image. This reduces and/or corrects the locally varying primary transmission of the grid and thus the grid artifacts.

The process also includes: (4) subsequently, the X-ray image is transformed back again.

The process may also include: (5) acts 1-4 may be repeated iteratively in order to improve the result. Acts 1-3 may also be applied locally to restricted regions of the X-ray image in order to optimize the result for local regions.

The process may also include: (6) the estimated scattered radiation information may possibly advantageously also be used for other purposes, for example, in the context of a 3D reconstruction.

The process may also include: (7) the knowledge regarding the primary transmission of the anti-scatter grid may possibly advantageously also be used for parameterizing a noise-removal filter or other imaging algorithms since, in regions with low primary transmission, the signal-to-noise ratio is reduced.

A method for reducing grid artifacts in X-ray images includes: receiving an X-ray image that has been recorded making use of an anti-scatter grid; generating an intermediate image by applying a logarithm transformation to the X-ray image; receiving at least one eigenvector or eigenvector image of the anti-scatter grid established by way of principal component analysis; adapting the at least one eigenvector or eigenvector image to the intermediate image; establishing a weight for at least one eigenvector or eigenvector image dependent upon the result of the adaptation; generating a corrected intermediate image by subtracting the at least one weighted eigenvector or eigenvector image from the intermediate image; and generating a corrected X-ray image by applying the inverse logarithm transformation to the corrected intermediate image.

The subtraction may take place in the vector space, meaning that the eigenvector(s) are subtracted from a projection of the uncorrected intermediate image into the vector space. The subtraction may, however, also be carried out in that the eigenvector(s) is or are projected into the image space and the resultant eigenvector image(s) is or are subtracted from the uncorrected intermediate image. For this reason, the expressions eigenvector and eigenvector image is used below as having the same meaning.

Principal component analysis involves a known mathematical method that is also referred to as a principal axis transformation. Principal component analysis is a statistical method that disassembles a multidimensional data field into a quantity of uncorrelated variables that are referred to as principal components. By way of the principal component analysis, a plurality of variables may be characterized by giving their main components. For a plurality of variables that are arranged along a line and about the line, this line would represent a principal component. The principal components are mapped by way of eigenvectors that are independent of one another, e.g., a change in the value of a variable in relation to an eigenvector brings about no change in the variable value in relation to other eigenvectors, and vice versa. The principal component analysis enables the recognition of patterns in the variables in that it represents the data in a new (eigenvector) coordinate system that reflects the inherent structure of the variables.

Advantageously, the dimensionality of the data may be reduced by way of principal component analysis by extracting the statistically most important features. Less relevant or redundant features may be eliminated and correlations between features may be minimized. This simplifies the further processing of the data. For example, in this way, the performance and accuracy of machine learning and data analysis algorithms may be improved.

Advantageously, the principal component analysis is less susceptible, particularly in comparison with the Fourier transform, to noise and artifacts that may be caused, for example, by movements or deformations of the C-arm or the patient, since it extracts the dominant pattern of the grid without needing the frequency information with its inherent assumption of the periodicity of the grid. Advantageously, the principal component analysis is efficient as regards storage and computation performance, since it needs only a limited number of eigenvector images to describe the grid, whereas, for example, the Fourier transform requires a complete spectral analysis of the image. Advantageously, the principal component analysis enables a more exact adaptation of the grid to the intermediate image, since it takes account of the orientation, size, and position of the grid without requiring therefor a spatially periodic configuration of the grid, whereas, for example, a Fourier transform requires a spatially periodic configuration of the grid and only enables the frequency and the phase of the grid to be determined in one dimension. Advantageously, it enables the principal component analysis to adapt the eigenvector image to different X-ray images that have been recorded with the same anti-scatter grid. Furthermore, it is even conceivable to adapt the eigenvector image to X-ray images that have been recorded with a similar anti-scatter grid (in respect of the eigenvectors).

It has been identified that, by way of the modeling by eigenvectors of the principal component analysis, deviations in the images of the anti-scatter grid may be compensated for. Slight deviations may result, for example, as the consequence of unwanted mechanical displacements of the grid during the movement of the X-ray system. A mapping of the anti-scatter grid may be generated as a mean value of a set of training images that has been recorded at different positions of the X-ray system or C-arm system. The slight deviations may be modeled by way of the eigenvectors of the principal component analysis.

An advantageous development of the method provides that before the generation of the intermediate image, the scattered radiation component of the X-ray image is estimated and is subtracted from the X-ray image.

Advantageously, in this way, the linearization of the absorption by the logarithm transformation is improved. The linearization of the absorption is itself advantageous for the subtraction of the eigenvector images.

The estimation of a scattered radiation component takes place with known methods such as that by Bastian Bier et al. cited above. This is possible in that a grid with a low frequency and therefore a primary transmission varying from pixel to pixel is used. In one embodiment, an estimated value applicable to the entire X-ray image may be established by minimizing the high frequency image components of the image by way of a suitable selection of the estimated value. In another embodiment, an estimated value applicable to individual pixels or image regions may be established by minimizing the high frequency image components of the image by way of optimizing all the respective estimated values together.

An advantageous development of the method provides that the at least one eigenvector or eigenvector image is formed in that X-ray images of the anti-scatter grid are recorded and in that a principal component analysis is carried out on the basis of the X-ray images of the anti-scatter grid.

An advantageous development of the method provides that before the principal component analysis is carried out, a mean image is formed from the X-ray images of the anti-scatter grid and is subsequently subtracted from the X-ray images of the anti-scatter grid and that the principal component analysis is carried out on the basis of the images resulting therefrom.

An advantageous development of the method provides that the establishment of the weight of an eigenvector includes a subtraction of the eigenvector from the intermediate image projected into the vector space.

Advantageously, the adaptation of an individual eigenvector to the X-ray image, wherein no further eigenvector images need to be taken into account, is particularly uncomplicated. In certain embodiments, a plurality of eigenvectors or eigenvector images may be used. Advantageously, the adaptation of the weights also takes place, if a plurality of eigenvector images is to be adapted, on the basis of the respective subtraction results. The subtraction results are uncomplicated to establish and the weights may be obtained by an optimization method that is common in the prior art.

An advantageous development of the method provides that the establishment of the weight of each eigenvector includes, for a plurality of eigenvectors, a subtraction of the respective weighted eigenvector from the intermediate image projected into the vector space. In this manner, a known optimization method may be applied for the optimization of a plurality of weights.

An advantageous development of the method provides that the establishment of the weight of an eigenvector includes a subtraction of the eigenvector from the intermediate image projected into the vector space and a minimizing of the high frequency image component of the resultant subtraction image.

Advantageously, by way of the adaptation on the basis of a minimization of high image frequencies, a high level of accuracy is provided, since in this way, the comparatively low-frequency influence of noise and artifacts due to scattered radiation is reduced and the comparatively high-frequency influence of the anti-scatter grid may be taken into greater account.

An advantageous development of the method provides that the establishment of the weight of each eigenvector includes, for a plurality of eigenvectors, a subtraction of the respective weighted eigenvector from the intermediate image projected into the vector space and a minimizing of the high-frequency image component of the subtraction image obtained after the plurality of subtractions. In this manner, a known optimization method may be applied for the optimization of a plurality of weights.

Advantageously, taking a plurality of eigenvectors of the anti-scatter grid into consideration by way of the adaptation on the basis of a plurality of eigenvector images provides a greater accuracy and thus a more effective reduction of grid artifacts.

Further advantages and details of the present disclosure are provided in the embodiments described below and by reference to the drawings.

### BRIEF DESCRIPTION OF THE DRAWINGS

FIG. 1 depicts a flow diagram of a first exemplary embodiment of the method.

FIG. 2 depicts an example of an X-ray facility.

### DETAILED DESCRIPTION

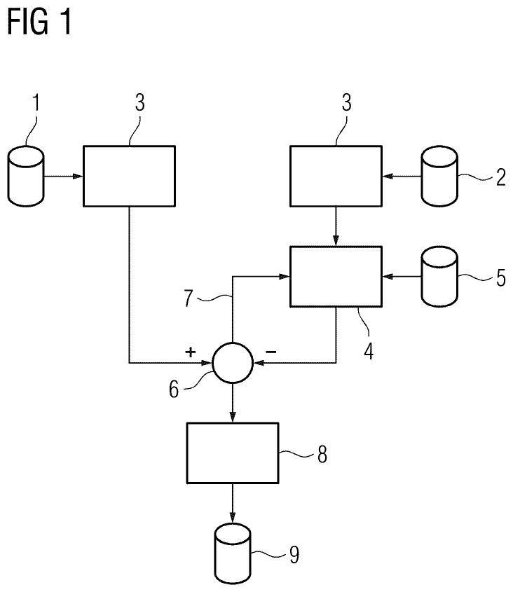

FIG. 1 shows a flow diagram of a first exemplary embodiment of the method. The starting point herein is an X-ray image 1 that has been recorded with an X-ray facility 13 making use of an anti-scatter grid 18. The X-ray image 1 is corrected with the aid of one or more calibration images 2 that show only the effects of the anti-scatter grid 18 and thus have been recorded without an imaging object.

The calibration image(s) 2 may be recorded by way of the X-ray facility 13 by recording images of the anti-scatter grid 18 with a high X-ray dose. For example, an image of the anti-scatter grid 18 may be recorded with a high X-ray dose. For example, a plurality of images of the anti-scatter grid 18 may be recorded that are then added together and/or averaged in order to establish the calibration image 2.

No phantom is used for recording the calibration image(s) 2. In the clinical routine, due to the transmission of the X-rays through the imaging object, a change in the energy spectrum of the X-ray radiation may take place, which is also referred to as “beam hardening.” In order to arrive at comparable image data during the recording of calibration images 2, a comparable effect is achieved by placing a strongly X-ray absorbing object in the X-ray beam path. This may be a copper filter. In order to avoid scattered radiation, the object may be placed in spatial proximity to the X-ray radiator.

In order to improve both the effectiveness of the method and the quality of the grid artifact reduction, advantageously, a plurality of calibration images 2 may be recorded. By way of the calibration images 2, a large number of possible imaging situations may be taken into account so that calibration information is obtained for a large number of imaging situations. For this purpose, for the recording of the calibration images 2, a series of imaging parameters may be varied, for example: x-ray voltage, pre-filtration of the X-ray radiation, focal spot size of the X-ray radiator, and/or geometric projection parameters for the recording (e.g., for a C-arm X-ray facility, changes in the projection in relation to cranial/caudal and RAO/LAO).

The calibration images 2 may be recorded, for example, with systematic variation of the imaging parameters. The calibration images 2 may be recorded, for example, with random variation of the imaging parameters. The calibration images 2 may be recorded, for example, with partially systematic and partially random variation of the imaging parameters.

In act 3, from the X-ray image 1 that may be stored in a storage facility of the control facility 21, an intermediate image is generated by way of a logarithm transformation. The calibration images 2, which may be stored in a storage facility of the control facility 21 of the X-ray facility 13, are subjected to a logarithm transformation in act 3. By this process, the X-ray images 1 and calibration images 2 are linearized for the further processing.

In order to carry out a calibration in relation to the intermediate image, in act 4, the calibration images 2 are subjected to a principal component analysis. A mean image is therein initially formed from the calibration images. The mean image is then subtracted from the calibration images 2. Based on the resultant mean value subtracted calibration images, a plurality of eigenvectors that statistically characterize the calibration images 2 is then obtained by way of the principal component analysis. The number of eigenvectors is restricted to a suitable amount in order to restrict the computation effort. The number is selected so that a suitable cost-benefit ratio may be obtained. The eigenvectors are stored in a storage facility 5.

The eigenvector images are then adapted (e.g., fitted) to the intermediate image generated from the X-ray image 1. In order to be able to adapt the eigenvectors to the intermediate image, both are situated in the same descriptive space, that is, either the vector space or the image space. In order to carry out the adaptation in the image space, therefore, the eigenvectors are projected into the image space. The adaptation may be carried out in the vector space, for which purpose the intermediate image is projected into the vector space.

The adaptation takes place by way of a weighting of the eigenvectors and/or the eigenvector images. Through the adaptation, a maximization of the degree of matching to the intermediate image is striven for. The maximization of the degree of matching corresponds to a minimization of the difference between the eigenvector images and the intermediate image. The optimization that may take place according to an optimization method is symbolized in the figure by the arrow 7.

In one embodiment, the adaptation may take place in that each individual eigenvector receives a weight corresponding to the amount of the deviation from the intermediate image. Eigenvectors that have a greater deviation from the intermediate image therefore receive a smaller weight than eigenvectors that have a smaller deviation from the intermediate image. The amount of the deviation is established by subtracting a projection of the respective logarithm-transformed eigenvector from a projection of the intermediate image into the vector space.

The adaptation may not take place for each individual eigenvector, but for all the eigenvectors that are to be adapted in total. The adaptation is therein a closed process across all the weights to be determined, e.g., the weights are not determined individually and independently of one another, but together and in mutual dependency. The weights may be established by way of a common and known optimization method. The adaptation is completed as soon as the amount of the deviation of the eigenvectors from the intermediate image in total across all the eigenvectors is minimized by way of a suitable choice of the weight of each eigenvector as far as a specified amount or until the run-throughs of the adaptation method meet a convergence criterion or until a specified number of run-throughs of the adaptation method has been completed.

In another embodiment, the adaptation may take place in that each eigenvector is given a respective weight. The individual weighted eigenvectors are subtracted from the intermediate image. As a result of the plurality of subtractions of the eigenvectors, a subtraction image is obtained. The weights are now selected by way of the adaptation so that the high frequency image portion of this subtraction image is minimized. Since the anti-scatter grid 18 is mapped in high-frequency image portions, the minimization of the high frequency image portion simultaneously also means a minimization of the image portions that are attributable to the anti-scatter grid 18. The adaptation may be completed as soon as a sufficient minimization of the high frequency image portion is ascertained according to a termination criterion, or as soon as the run-throughs of the adaptation method meet a convergence criterion or as soon as a specified number of adaptation runs has been completed.

Once the adaptation and thus the weighting is completed, in act 6, in order to reduce the grid artifacts, the weighted eigenvector images of the anti-scatter grid 18 are subtracted from the intermediate image. The result is a reduction in the undesirable image portions that have been caused by the anti-scatter grid 18 in the intermediate image, and which have been perceived in the X-ray image 1 as interfering grid artifacts.

The intermediate image that has been corrected or improved with regard to grid artifacts is subjected in act 8 to an inverse logarithm transformation in order to obtain a corrected X-ray image 9 again. The corrected X-ray image 9 may be stored in a storage facility of the control facility 21 and displayed, by way of the control facility 21 of the X-ray facility 13, on a display.

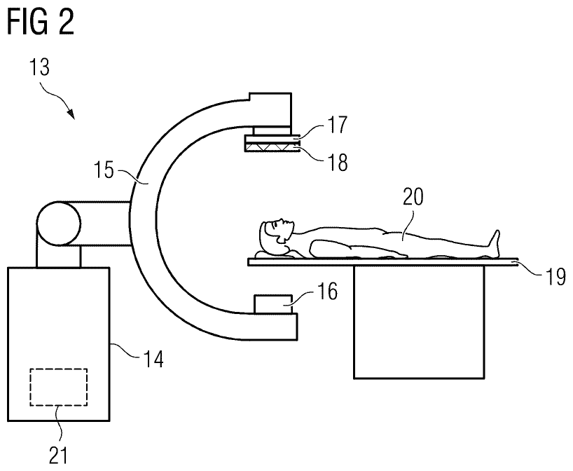

FIG. 2 shows a sketch of the principle of an X-ray facility 13, which is configured as a C-arm X-ray facility. This includes a C-arm 15 arranged on a stand 14. An X-ray radiator 16 and an X-ray detector 17 are arranged opposite one another on the C-arm 15. Arranged directly in front of the X-ray detector 17 is an anti-scatter grid 18 that is constructed in the form of a grid. The grid may have any desired structure and does not need to be a spatially periodically repeating structure.

By the C-arm 15, the recording arrangement formed by the X-ray radiator 16 and the X-ray detector 17 may be moved into various recording positions relative to a patient 20 positioned on a patient table 19. The C-arm 15 may be rotated, inter alia, cranially/caudally, i.e., in the direction of the head and/or feet of the patient 20 and RAO/LAO (right anterior obliquely/left anterior obliquely), i.e., right or left about the patient.

The operation of the X-ray apparatus 13 is controlled via a control facility 21, which is configured for carrying out the method as described herein. This means that whenever a new X-ray image has been recorded, an adaptation for the eigenvectors and/or eigenvector images stored in a storage facility of the control facility 21 is carried out as described above, so that the best possible correction of the image effects caused by the anti-scatter grid 18, in particular, grid artifacts, takes place.

The method may also exist in the form of a computer program by which a performance of the method on the control facility 21 is initiated when the computer program is executed on the control device 21. The method may also exist on a non-transitory electronically readable data carrier (not shown) in the form of electronically readable control information stored thereon, said control information including a computer program and being configured such that, on use of the data carrier in the control facility 21 of the X-ray facility 13, it initiates a performance of the method as described herein.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for reducing grid artifacts in X-ray images, the method comprising:
receiving an X-ray image that has been recorded while making use of an anti-scatter grid;
generating an intermediate image by applying a logarithm transformation to the X-ray image;
receiving at least one eigenvector or eigenvector image of the anti-scatter grid established by way of principal component analysis;
adapting the at least one eigenvector or eigenvector image to the intermediate image;
establishing a weight for the at least one eigenvector or eigenvector image dependent upon a result of the adaptation to provide at least one weighted eigenvector or eigenvector image;
generating a corrected intermediate image by subtracting the at least one weighted eigenvector or eigenvector image from the intermediate image; and
generating a corrected X-ray image by applying an inverse logarithm transformation to the corrected intermediate image.

2. The method as claimed in claim 1, further comprising, before the generating of the intermediate image:
estimating a scattered radiation component of the X-ray image; and
subtracting the estimated scattered radiation component from the X-ray image.

3. The method of claim 2, wherein the at least one eigenvector or eigenvector image is formed in that X-ray images of the anti-scatter grid are recorded and the principal component analysis is carried out based on the X-ray images of the anti-scatter grid.

4. The method of claim 3, wherein, before the principal component analysis is carried out, a mean image is formed from the X-ray images of the anti-scatter grid and is subsequently subtracted from the X-ray images of the anti-scatter grid and the principal component analysis is carried out based on the images resulting therefrom.

5. The method of claim 2, wherein the establishing of the weight comprises subtracting the at least one eigenvector from the intermediate image projected into a vector space.

6. The method of claim 2, wherein the at least one eigenvector comprises a plurality of eigenvectors, and
wherein the establishing of the weight of each eigenvector of the plurality of eigenvectors comprises subtracting the respective weighted eigenvector from the intermediate image projected into a vector space.

7. The method of claim 2, wherein the establishing of the weight comprises subtracting of the at least one eigenvector from the intermediate image projected into a vector space and minimizing a high frequency image component of a resultant subtraction image.

8. The method of claim 1, wherein the at least one eigenvector or eigenvector image is formed in that X-ray images of the anti-scatter grid are recorded and the principal component analysis is carried out based on the X-ray images of the anti-scatter grid.

9. The method of claim 8, wherein, before the principal component analysis is carried out, a mean image is formed from the X-ray images of the anti-scatter grid and is subsequently subtracted from the X-ray images of the anti-scatter grid and the principal component analysis is carried out based on the images resulting therefrom.

10. The method of claim 1, wherein the establishing of the weight comprises subtracting the at least one eigenvector from the intermediate image projected into a vector space.

11. The method of claim 1, wherein the at least one eigenvector comprises a plurality of eigenvectors, and
wherein the establishing of the weight of each eigenvector of the plurality of eigenvectors comprises subtracting the respective weighted eigenvector from the intermediate image projected into a vector space.

12. The method of claim 1, wherein the establishing of the weight comprises subtracting of the at least one eigenvector from the intermediate image projected into a vector space and minimizing a high frequency image component of a resultant subtraction image.

13. The method of claim 1, wherein the at least one eigenvector comprises a plurality of eigenvectors, and
wherein the establishing of the weight of each eigenvector of the plurality of eigenvectors comprises subtracting each weighted eigenvector from the intermediate image projected into a vector space and minimizing a high-frequency image component of a subtraction image obtained after a plurality of subtractions.

14. An X-ray facility comprising:
a control facility configured to:
receive an X-ray image that has been recorded while making use of an anti-scatter grid;
generate an intermediate image by applying a logarithm transformation to the X-ray image;
receive at least one eigenvector or eigenvector image of the anti-scatter grid established by way of principal component analysis;
adapt the at least one eigenvector or eigenvector image to the intermediate image;
establish a weight for the at least one eigenvector or eigenvector image dependent upon a result of the adaptation to provide at least one weighted eigenvector or eigenvector image;
generate a corrected intermediate image by subtracting the at least one weighted eigenvector or eigenvector image from the intermediate image; and
generate a corrected X-ray image by applying an inverse logarithm transformation to the corrected intermediate image.

15. A non-transitory electronically readable data carrier on which a computer program is stored, wherein the computer program, when executed by a computing facility of an X-ray facility, is configured to cause the computing facility to:
receive an X-ray image that has been recorded while making use of an anti-scatter grid;
generate an intermediate image by applying a logarithm transformation to the X-ray image;
receive at least one eigenvector or eigenvector image of the anti-scatter grid established by way of principal component analysis;
adapt the at least one eigenvector or eigenvector image to the intermediate image;
establish a weight for the at least one eigenvector or eigenvector image dependent upon a result of the adaptation to provide at least one weighted eigenvector or eigenvector image;
generate a corrected intermediate image by subtracting the at least one weighted eigenvector or eigenvector image from the intermediate image; and
generate a corrected X-ray image by applying an inverse logarithm transformation to the corrected intermediate image.
